(19) United States
(12) Patent Application Publication
(10) Pub. No.: US 2015/0281264 A1
(43) Pub. Date: Oct. 1, 2015

(54) SECURITY DATA PROCESSING METHOD AND SYSTEM

(71) Applicant: BEIJING QIHOO TECHNOLOGY COMPANY LIMITED, Xicheng District, Beijing (CN)

(72) Inventors: Zhenbo Deng, Beijing (CN); Jiazhu Zhang, Beijing (CN); Ming Wen, Beijing (CN); Yu Li, Beijing (CN); Jiao Liu, Beijing (CN)

(21) Appl. No.: 14/646,772

(22) PCT Filed: Sep. 27, 2013
(86) PCT No.: PCT/CN2013/084388

§ 371 Date: May 22, 2015

(30) Foreign Application Priority Data
Nov. 26, 2012 (CN) 201210488724.6

(51) Int. Cl. H04L 29/06; H04L 29/08; G06F 21/50

(52) U.S. Cl. CPC H04L 63/1408; H04L 63/10; G06F 21/50; H04L 67/1085

(57) ABSTRACT

a security data processing method comprises the following steps that: a security control server receives a data upload request from a terminal, and obtains file features and an identification code of the terminal included in the data upload request; the security control server judges whether the terminal is a trustable machine according to the identification code of the terminal, wherein the trustable machine is a terminal in which data is considered to be security data; if the terminal is judged as the trustable machine, the security control server obtains a real-time state of the terminal from a real-time state record table, and adds the uploaded file feature to a security database if the terminal is in a working state, and does not add the uploaded file feature to the security database if the terminal is in an idle state. The present invention also provides a security data processing system for implementing the forgoing method. The security data processing method and system of the present invention can improve the security data updating efficiency.

The present application claims the benefit of the Chinese patent application No.201210488724.6 entitled “Security Data Processing Method and System” and submitted to the Chinese Patent Office on Nov. 26, 2012, the disclosure of which is incorporated herein in its entirety by reference.

### FIELD OF THE INVENTION

The present invention relates to the computer security technical field, and specifically to a security data processing method and system.

### BACKGROUND OF THE INVENTION

Private cloud is a computer security system individually deployed for an enterprise and can effectively ensure security of internal data. Generally speaking, in a private cloud system, a terminal uploads file feature information whose security cannot be distinguished locally to a security control server, the security control server identifies the file feature information through an internally-stored security information database, and transmits the identification result to the terminal so that security management of internal data can be achieved.

This manner can ensure security of internal data of the enterprise. However, when the terminal uploads a large amount of data to the security control server, or an uploading concurrency is larger, the security control server usually cannot respond quickly and reduces the processing efficiency, and even might cause questions such as the security control server's failure to respond when serious. When the security control server does not have relevant file feature information, the file feature information uploaded by the terminal cannot be identified. Therefore, this manner has higher requirements for time-effectiveness of data in the security information database in the security control server. To ensure effective and accurate identification of the file feature information uploaded by the terminal, the security control server needs to update the security information data in real time and quickly. However, currently the update usually needs to be implemented manually, or implemented by comparing the file features one by one, so the time spent in updating is longer and the efficiency is lower.

### SUMMARY OF THE INVENTION

In view of the above problems, the present invention is proposed to provide a security data processing method and system, which can overcome the above problems or at least partially solve the above problems.

According to an aspect of the present application, a security data processing method is provided, comprising the following steps:

a security control server receiving a data upload request from a terminal, and obtaining a file feature and an identification code of the terminal included in the data upload request;

the security control server judging whether the terminal is a trustable machine according to the identification code of the terminal, wherein the trustable machine is a terminal in which data is considered to be security data;

if the terminal is judged as the trustable machine, the security control server obtaining a real-time state of the terminal from a real-time state record table, and adding the uploaded file feature to a security database if the terminal is in a working state, and not adding the uploaded file feature to the security database if the terminal is in an idle state.

Optionally, the method further comprises:

altering real-time state of the terminal, wherein the real-time state of the terminal comprises a working state and an idle state;

the security control server updating the real-time state of all terminals in the real-time state record table according to the altered real-time state.

Optionally, the step of altering the real-time state of the terminal is performed in the terminal, and the method further comprises the terminal transmitting the real-time state to the security control server after the real-time state is altered;

the step of altering the real-time state of the terminal comprises:

monitoring a time period after the terminal uploads the file feature, and altering the working state of the terminal to the idle state if beyond a first predetermined time period; and/or

monitoring a time period after the terminal powers on, and altering the working state of the terminal to the idle state if beyond a second predetermined time period.

Optionally, the step of monitoring a time period after the terminal uploads the file feature comprises:

upon monitoring that the terminal uploads the file feature, uploading a first timing configuration file whose monitoring duration is the first predetermined time period; and/or

the step of monitoring a time period after the terminal powers on comprises: when the terminal powers on, uploading a second timing configuration file whose monitoring duration is the second predetermined time period.

Optionally, he step of altering the real-time state of the terminal is performed in the security control server, and the step of altering the real-time state of the terminal comprises:

the security control server monitoring an externally-input alteration command, and according to the alteration command, altering the terminal from the working state to the idle state or from the idle state to the working state.

Optionally, the step of the security control server monitoring an externally-input alteration command, and according to the alteration command, altering the terminal from the working state to the idle state or from the idle state to the working state comprises:

obtaining the externally-input alteration command and the identification code of the terminal;

performing real-time state alteration for the terminal having the identification code according to the alteration command.

Optionally, the method further comprises:

identifying security of file feature information uploaded by other terminals by using the file feature added to the security database.

Optionally, t the security data processing method is implemented in an enterprise intranet.

Optionally, the real-time state record table is stored in the security control server, and the security control server updates it according to information obtained in real time.

According to another aspect of the present invention, a security data processing system disposed in a security control server is provided, comprising:

an information receiving module configured to receive a data upload request from a terminal, and obtain a file feature and an identification code of the terminal included in the data upload request;

a trustable machine judging module configured to judge whether the terminal is a trustable machine according to the identification code of the terminal, and trigger a real-time state obtaining module if the terminal is a trustable machine, wherein the trustable machine is a terminal in which data is considered to be security data;

the real-time state obtaining module configured to obtain a real-time state of the terminal from a real-time state record table, and add the uploaded file feature to a security database if the terminal is in a working state, and not add the uploaded file feature to the security database if the terminal is in an idle state.

Optionally, the system further comprises:

a real-time state altering module configured to alter the real-time state of the terminal, wherein the real-time state of the terminal including a working state and an idle state; and

an updating module disposed in the security control server and configured to update the real-time state of all terminals in the real-time state record table of the security control server according to an alteration operation of the real-time state altering module.

Optionally, the real-time state altering module is disposed in the terminal, and the system further comprises:

a data transmitting module disposed in the terminal and configured to transmits the real-time state to the updating module in the security control server after the real-time state of the terminal is altered;

the real-time state altering module comprises:

a time period monitoring submodule configured to monitor a time period after the terminal uploads the file feature, and alter the working state of the terminal to the idle state if beyond a first predetermined time period; and/or monitor a time period after the terminal powers on, and alter the working state of the terminal to the idle state if beyond a second predetermined time period.

Optionally, the real-time state altering module is disposed in the security control server, and comprises:

a command receiving submodule configured to monitor an externally-input alteration command in the security control server, and according to the alteration command, alter the terminal from the working state to the idle state or from the idle state to the working state.

Optionally, the command receiving submodule comprises:

an information obtaining unit configured to obtain the externally-input alteration command and the identification code of the terminal;

an altering unit configured to perform real-time state alteration for the terminal having the identification code according to the alteration command.

Optionally, the system further comprises:

an identifying and comparing module configured to identify security of file feature information uploaded by other terminals by using the file feature added to the security database.

According to the security data processing method and system of the present application, through division and transformation of the real-time state of the terminal set as the trustable machine as stated above, a terminal in working state can be trusted by the security control server, and security verification needs to be performed for a terminal in idle state, and the terminal can be trusted by the security control server only when it is in the working state again. Even though the trustable machine in the idle state is counterfeited, the security control server does not trust information uploaded by it so that the security of data in the security control server can be guaranteed very well. During this procedure, security monitoring of the trustable machine may be achieved only by maintaining a real-time state record table in the security control server, thereby improving the updating efficiency of the security data and reducing maintenance cost while guaranteeing security.

The above description only generalizes technical solutions of the present invention. The present invention may be implemented according to the content of the description in order to make technical means of the present invention more apparent. Specific embodiments of the present invention are exemplified to make the above and other objects, features and advantages of the present invention more apparent.

### BRIEF DESCRIPTION OF THE DRAWINGS

Various other advantages and merits will become apparent to those having ordinary skill in the art by reading through the following detailed description of preferred embodiments. Figures are only intended to illustrate preferred embodiments and not construed as limiting the present invention. In all figures, the same reference numbers denote the same part. In the figures:

FIG. 1 illustrates a flow chart of a security data processing method according to the first embodiment of the present invention;

FIG. 2 illustrates a flow chart of a security data processing method according to the second embodiment of the present invention;

FIG. 3 illustrates a block diagram of a security data processing system according to the first embodiment of the present invention; and

FIG. 4 illustrates a block diagram of a security data processing system according to the second embodiment of the present invention.

### DETAILED DESCRIPTION OF THE INVENTION

Exemplary embodiments of the present disclosure will be described in more detail with reference to the accompanying drawings. Although the drawings show the exemplary embodiments of the present disclosure, it should be appreciated that the present disclosure may be implemented in various forms and should be not limited by the embodiment described here. On the contrary, these embodiments are provided to make the present disclosure more apparent and entirely convey the scope of the present disclosure to those skilled in the art.

A security data processing method according to an embodiment of the present application is intended to process data security of an enterprise intranet and applied to a private cloud system in the enterprise. A security control server in the private cloud system is used to achieve identification and judgment, complete update of a security database of the enterprise intranet, and ensure timeliness and efficiency of update of the security database. In the above, the security control server refers to a service terminal which is set safe in the private cloud system. Generally speaking, the private cloud system might have only one service terminal, or when there are a plurality of service terminals, all service terminals need to be guaranteed secure, whereupon the security control sever may be all service terminals.

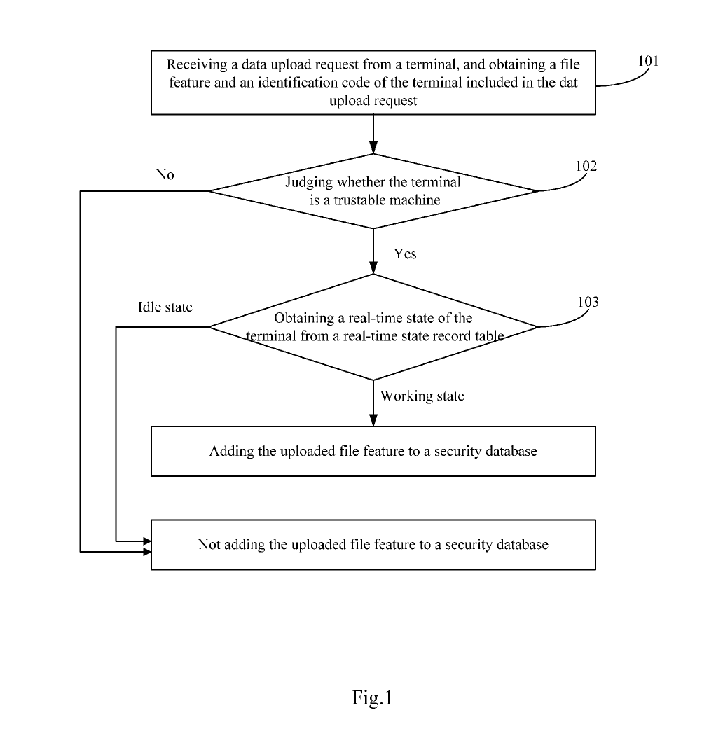

A security data processing method according to the first embodiment of the present application as shown in FIG. 1 comprises the following steps (Step 101-Step 103).

At Step 101, a security control server receives a data upload request from a terminal, and obtains a file feature and an identification code of the terminal from the request.

In the security control server of the private cloud system, identification codes of all terminals performing data interaction with the security control server are pre-stored. Specifically, the storage may be performed in a manner such as a configuration file or a relationship table, wherein the identification code of the terminal may be an identifier such as a serial number and a feature code of the terminal, which can solely identify the terminal. The file feature may be a MD5 value of the file or other identification data that can identify the file.

When the terminal uploads data to the security control server, the data upload request includes the identification code of the terminal and file feature to be uploaded. The security control server may directly acquire the information from the upload request of the terminal.

At step 102, the security control server judges whether the terminal is a trustable machine according to the identification code of the terminal, and step 103 will be performed if the terminal is a trustable machine, wherein, the trustable machine is a terminal in which data is considered to be security data.

In the above, the trustable machine may be set and maintained manually, i.e., a security information operator may set a level of some terminals in the cloud system as secure according to predetermined rules and manners, namely, set these terminals as trustable machines, and store relevant information in the security control server. The security control server may trust these terminals, data in the terminal set as trustable machine are considered as security data, and the file or file feature information uploaded by the terminals may be considered as secure.

Specifically, the security control server pre-identifies whether a terminal is a trustable machine, and a relevant identifier may be stored in a configuration file or relationship table. When the security control server acquires the identification code of the terminal, it may judge whether the terminal is a trustable machine by querying the configuration file or relationship table. If the terminal is a trustable machine, further judgment will be performed. If the terminal is not a trustable machine, the file feature will not be added to the security database, whereupon the upload request may be processed according to actual situations. If the upload request is about adding the file feature to the security database, the security control server may reject the upload request or does not respond, and if the upload request is about identifying the file feature, the file feature may be compared with the information already stored in the security database, then an identification result is returned to the terminal.

At step 103, the security control server obtains a real-time state of the terminal from a real-time state record table, and adds the uploaded file feature to a security database if the terminal is in a working state, and does not add the uploaded file feature to the security database if the terminal is in an idle state.

In embodiments of the present application, the real-time state of the terminal which is set as the trustable machine comprises two states, namely, a working state and an idle state. For the terminal which is set as the trustable machine, the security control server only trusts the terminal in the working state, and the security control server will not trust the file uploaded by the terminal when the terminal is in the idle state. In this way, the security of the uploaded data can be ensured. The upload request of the terminal judged as being in the idle state may be processed according actual situation. If the upload request is about adding the file feature to the security database, the security control server may reject the upload request or does not respond, and if the upload request is about identifying the file feature, the file feature may be compared with the information already stored in the security database, then an identification result is returned to the terminal.

It may be appreciated that for the file feature added to the security database, the security control server may be configured to perform security management of intranet data, e.g., configured to compare and identify file features uploaded by other terminals, for example, judge security of file features uploaded subsequently.

During actual processing according to embodiments of the present application, the real-time state of the terminal which is set as the trustable machine needs to be monitored, and the real-time state of the terminal be updated according to monitored situations. A real-time state record table is maintained in the security control server. When the real-time state of the terminal considered as the trustable machine changes, corresponding amendments need to be made to the real-time state record table to thereby ensure that what is stored in the security control server is the latest state. In order to guarantee timeliness of data read and security of data, the real-time state record table is preferably stored in the security control server. It may be appreciated that the real-time state record table may also be stored in other servers or databases, and the security control server may directly read information therein from a storage location if necessary.

In the above, monitoring and altering of the real-time state of the terminal may be performed either in the security control server or in the terminal.

When the monitoring and altering is performed in the security control server, the altering of the real-time state of the terminal includes: the security control server monitors an externally-input alteration command, and according to the alteration command, alters the terminal from the working state to the idle state or from the idle state to the working state. Specifically, the above procedure may be implemented in the following way: obtaining the externally-input alteration command and the identification code of the terminal; performing real-time state alteration for the terminal having the identification code according to the alteration command. Besides, for the terminal in the working state, the security control server may also perform the alteration by judging whether there is data interaction between the terminal and the security control server in a predetermined period of time. If, beyond the predetermined period of time, there is no data interaction between the terminal and the security control server, the security control server may alter the working state of the terminal to the idle state.

When the monitoring and altering is performed in the terminal, the terminal needs to transmit the altered real-time state to the security control server in real time to enable the security control server to update the real-time state record table. In this case, the altering of the real-time state of the terminal includes: monitoring a time period after the terminal uploads the file feature, and altering the working state of the terminal to the idle state if beyond a first predetermined time period; and/or monitoring a time period after the terminal powers on, and altering the working state of the terminal to the idle state if beyond a second predetermined time period. The monitoring of time period may be implemented by a timer or a configuration file. Take the configuration file as an example. The monitoring a time period after the terminal uploads the file feature may employ the following manner: upon monitoring that the terminal uploads the file feature, uploading a first timing configuration file whose monitoring duration is the first predetermined time period. The monitoring a time period after the terminal powers on may employ the following manner: when the terminal powers on, uploading a second timing configuration file whose monitoring duration is the second predetermined time period.

It shall be understood that one of the aforesaid time period monitoring manners may be selected as a triggering condition for alteration, or the two manners may be combined. That is to say, only the time period after the terminal uploads the file feature may be monitored or only the time period after the terminal powers on is monitored, or the two time periods are monitored simultaneously. Alteration of the real-time state is triggered so long as one of the conditions is satisfied.

As stated above, to guarantee the security of the trustable machine, alteration from the working state to the idle state may be triggered through in many ways as stated above so long as one of the conditions is satisfied. The alternation from the idle state to the working state needs to be performed in a way that a control command is input externally. In this way, forging of the trustable machine may be avoided and data security be guaranteed.

Through division and transformation of the real-time state of the terminal set as the trustable machine as stated above, the terminal in the working state can be trusted by the security control server, and security verification needs to be performed for the terminal in the idle state, and it can be trusted by the security control server only when it is in the working state again. Even though the trustable machine in the idle state is counterfeited, the security control server does not trust the information uploaded by it so that the security of the data in the security control server can be guaranteed very well. During this procedure, security monitoring of the trustable machine may be achieved only by maintaining the real-time state record table in the security control server, thereby improving the updating efficiency of the security data and reducing maintenance cost while guaranteeing security.

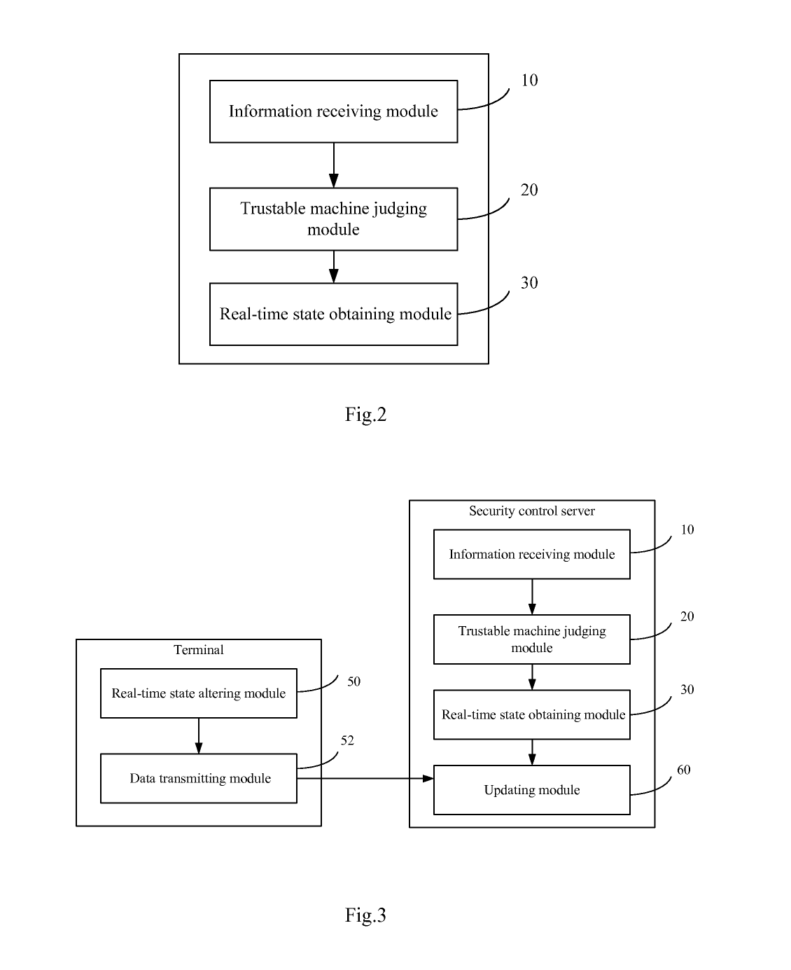

Referring to FIG. 2, a security data processing system disposed in the security control server according to the first embodiment of the present application includes an information receiving module 10, a trustable machine judging module 20 and a real-time state obtaining module 30.

The information receiving module 10 is configured to receive a data upload request from a terminal, and obtain a file feature and an identification code of the terminal included in the data upload request.

The trustable machine judging module 20 is configured to judge whether the terminal is a trustable machine according to the identification code of the terminal, and trigger the real-time state obtaining module if the terminal is a trustable machine, wherein the trustable machine is a terminal in which data is considered to be security data.

The real-time state obtaining module 30 is configured to obtain a real-time state of the terminal from a real-time state record table, and add the uploaded file feature to a security database if the terminal is in a working state, and not add the uploaded file feature to the security database if the terminal is in an idle state.

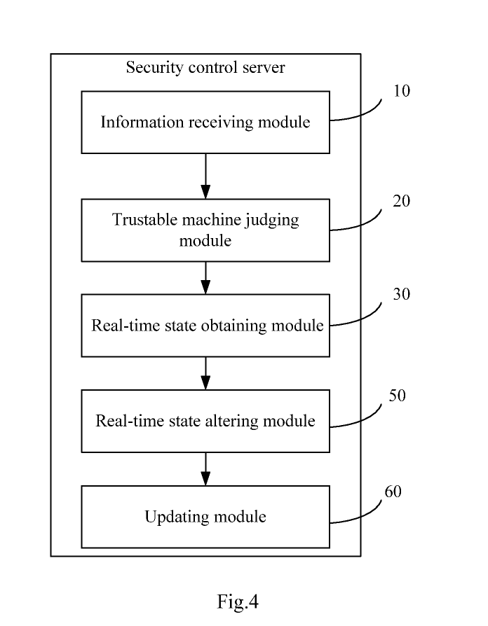

Preferably, the security date processing system also includes a real-time state altering module 50 and an updating module 60 (as shown in FIG. 3 and FIG. 4), wherein the real-time state altering module may be disposed either in the security control server or in the terminal, or simultaneously in both the security control server and the terminal.

The real-time state altering module is configured to alter the real-time state of the terminal including a working state and an idle state.

The updating module is disposed in the security control server and configured to update the real-time state of all terminals in the real-time state record table of the security control server according to an alteration operation of the real-time state altering module.

Referring to FIG. 3, a security data processing system according to the second embodiment of the present application, when the real-time state altering module 50 is disposed in the terminal, also includes a data transmitting module 52 which is disposed in the terminal and configured to transmit the real-time state to the updating module 60 in the security control server after the real-time state is altered. In this case, the real-time state altering module includes a time period monitoring submodule configured to monitor a time period after the terminal uploads the file feature, and alter the working state of the terminal to the idle state if beyond a first predetermined time period; and/or monitor a time period after the terminal powers on, and alter the working state of the terminal to the idle state if beyond a second predetermined time period.

Referring to FIG. 4 illustrating the third embodiment of the security data processing system of the present application, the real-time state altering module 50 is disposed in the security control server, whereupon it includes a command receiving submodule configured to monitors an externally-input alteration command in the security control server, and according to the alteration command, alter the terminal from the working state to the idle state or from the idle state to the working state. In this case, the real-time state altering module 50 needs to transmit the alteration operation to the updating module 60 to enable it to update the real-time state of all terminals in the real-time state record table of the security control server.

Preferably, the command receiving submodule includes an information obtaining unit and an altering unit. The information obtaining unit is configured to obtain the externally-input alteration command and the identification code of the terminal. The altering unit is configured to perform real-time state alteration for the terminal having the identification code according to the alteration command.

It may be understood that on the basis of the above embodiments, the system further includes an identifying and comparing module configured to identify security of file feature information uploaded by other terminals by using the file feature added to the security database.

The present application further provides a computer readable recording medium on which a program for executing the apparatus controlling method according to any one of the aforesaid first to fourth embodiments is recorded. The computer readable recording medium comprises any mechanism for storing or transmitting information in a computer readable form. For example, the computer readable medium comprises a Read Only Memory (ROM), Random Access Memory (RAM), magnetic disk storage medium, optical storage medium, flash storage medium, a propagation signal in an electrical, optical, acoustic or other form (e.g., a carrier, infrared signal, digital signal) and the like.

The algorithm and display provided herein are not intrinsically related to any specific computer, virtual system or other devices. Various general systems may also be used together with a teaching based on this. According to the above depictions, structures required for constructing such type of systems are obvious. Besides, the present application is not with respect to any specific programming language. It shall be understood that various programming languages may be used to implement the content of the present application described here, and the above depictions for a specific language are intended to reveal preferred embodiments of the present application.

The description as provided here describes a lot of specific details. However, it is appreciated that embodiments of the present invention may be implemented in the absence of these specific details. Some embodiments do not specify in detail known methods, structures and technologies to make the description apparent.

Similarly, it should be appreciated that in order to simplify the present disclosure and help understand one or more aspects of the present invention, in the above depictions of exemplary embodiments of the present application, features of the present application are sometimes grouped together to an individual embodiment, figure or depiction thereof. However, the disclosed method should not be interpreted as the following intention: the present application claims more features than the features explicitly recited in each claim. More exactly, as reflected by the following claim set, aspects of the invention are less than all features of an individual embodiment disclosed previously. Therefore, the claim set conforming to a specific implementation mode is thereby explicitly incorporated into this specific implementation mode, wherein each claim itself serves as an individual embodiment of the present application.

Those skilled in the art may appreciate that modules in the apparatus in the embodiment may be changed adaptively and they are set in one or more apparatuses different from the present embodiment. Modules or units or assemblies in the embodiment may be combined into one module or unit or assembly, and besides, they may be divided into a plurality of submodules, subunits or subassemblies. Except that at least some of such features and/or processes or units are mutually repellent, all features disclosed in the specification (including the accompanying claims, abstract and figures) and all processes or units of any method or apparatus disclosed in this way may be combined by employing any combination. Unless otherwise stated expressly, each feature disclosed in the specification (including the accompanying claims, abstract and figures) may be replaced with an alternative feature providing identical, equivalent or similar objective.

In addition, those skilled in the art can understand that even though some embodiments described here include some features other than other features included in other embodiments, combination of features of different embodiments means being within the scope of the present application and forming different embodiments. For example, in the appended claim set, any one of the claimed embodiments may be used in an arbitrary combination manner.

Embodiments regarding parts in the present invention may be implemented in hardware, or implemented by software modules running on one or more processors, or implemented in their combinations. Those skilled in the art should understand that a microprocessor or digital signal processor (DSP) may be used in practice to implement some or all functions of some or all parts of the apparatus according to embodiments of the present invention. The present invention may also be implemented as an apparatus or device program (e.g., computer program and computer program product) for executing part or all of the method described here. Such programs implementing the present invention may be stored in a computer-readable medium, or may be in a form having one or more signals. Such signals can be obtained by downloading from the Internet, or provided on a carrier signal or provided in any other forms.

It should be noted that the above embodiment illustrate the present invention but are not intended to limit the present invention, and those skilled in the art may design alternative embodiments without departing from the scope of the appended claims. In claims, any reference signs placed in parentheses should not be construed as limiting the claims. The word “comprising” does not exclude the presence of elements or steps not listed in a claim. The word “a” or “an” preceding an element does not exclude the presence of a plurality of such elements. The present invention may be implemented by virtue of hardware including several different elements and by virtue of a properly-programmed computer. In the apparatus claims enumerating several units, several of these units can be embodied by one and the same item of hardware. The usage of the words first, second and third, et cetera, does not indicate any ordering. These words are to be interpreted as names.

1. A security data processing method, comprising the following steps:
a security control server receiving a data upload request from a terminal, and obtaining a file feature and an identification code of the terminal included in the data upload request;
the security control server judging whether the terminal is a trustable machine according to the identification code of the terminal, wherein the trustable machine is a terminal in which data is considered to be security data;
if the terminal is judged as the trustable machine, the security control server obtaining a real-time state of the terminal from a real-time state record table, and adding the uploaded file feature to a security database if the terminal is in a working state, and not adding the uploaded file feature to the security database if the terminal is in an idle state.

2. The security data processing method according to claim 1, wherein the method further comprising:
altering real-time state of the terminal, wherein the real-time state of the terminal comprises a working state and an idle state;
the security control server updating the real-time state of all terminals in the real-time state record table according to the altered real-time state.

3. The security data processing method according to claim 2, wherein the step of altering the real-time state of the terminal is performed in the terminal, and the method further comprises the terminal transmitting the real-time state to the security control server after the real-time state is altered;
the step of altering the real-time state of the terminal comprises:
monitoring a time period after the terminal uploads the file feature, and altering the working state of the terminal to the idle state if beyond a first predetermined time period; and/or
monitoring a time period after the terminal powers on, and altering the working state of the terminal to the idle state if beyond a second predetermined time period.

4. The security data processing method according to claim 3, wherein the step of monitoring a time period after the terminal uploads the file feature comprises:
upon monitoring that the terminal uploads the file feature, uploading a first timing configuration file whose monitoring duration is the first predetermined time period; and/or
the step of monitoring a time period after the terminal powers on comprises: when the terminal powers on, uploading a second timing configuration file whose monitoring duration is the second predetermined time period.

5. The security data processing method according to claim 2, wherein the step of altering the real-time state of the terminal is performed in the security control server, and the step of altering the real-time state of the terminal comprises:
the security control server monitoring an externally-input alteration command, and according to the alteration command, altering the terminal from the working state to the idle state or from the idle state to the working state.

6. The security data processing method according to claim 5, wherein the step of the security control server monitoring an externally-input alteration command, and according to the alteration command, altering the terminal from the working state to the idle state or from the idle state to the working state comprises:
obtaining the externally-input alteration command and the identification code of the terminal;
performing real-time state alteration for the terminal having the identification code according to the alteration command.

7. The security data processing method according to claim 1, wherein the method further comprises:
identifying security of file feature information uploaded by other terminals by using the file feature added to the security database.

8. The security data processing method according to claim 1, wherein the security data processing method is implemented in an enterprise intranet.

9. The security data processing method according to claim 1, wherein the real-time state record table is stored in the security control server, and the security control server updates it according to information obtained in real time.

10. A security data processing system disposed in a security control server, comprising at least one processor to execute a plurality of modules comprising:
an information receiving module configured to receive a data upload request from a terminal, and obtain a file feature and an identification code of the terminal included in the data upload request;
a trustable machine judging module configured to judge whether the terminal is a trustable machine according to the identification code of the terminal, and trigger a real-time state obtaining module if the terminal is a trustable machine, wherein the trustable machine is a terminal in which data is considered to be security data;
the real-time state obtaining module configured to obtain a real-time state of the terminal from a real-time state record table, and add the uploaded file feature to a security database if the terminal is in a working state, and not add the uploaded file feature to the security database if the terminal is in an idle state.

11. The security data processing system according to claim 10, wherein the system further comprises:
a real-time state altering module configured to alter the real-time state of the terminal, wherein the real-time state of the terminal including a working state and an idle state; and
an updating module disposed in the security control server and configured to update the real-time state of all terminals in the real-time state record table of the security control server according to an alteration operation of the real-time state altering module.

12. (canceled)

13. The security data processing system according to claim 11, wherein the real-time state altering module is disposed in the security control server, and comprises:
a command receiving submodule configured to monitor an externally-input alteration command in the security control server, and according to the alteration command, alter the terminal from the working state to the idle state or from the idle state to the working state.

14. The security data processing system according to claim 13, wherein the command receiving submodule comprises:
an information obtaining unit configured to obtain the externally-input alteration command and the identification code of the terminal;
an altering unit configured to perform real-time state alteration for the terminal having the identification code according to the alteration command.

15. The security data processing system according to claim 10, wherein the system further comprises:
an identifying and comparing module configured to identify security of file feature information uploaded by other terminals by using the file feature added to the security database.

16. A non-transitory computer readable recording medium having instructions stored thereon that, when executed by at least one processor, cause the at least one processor to perform a security data processing method, which comprises the steps of:
a security control server receiving a data upload request from a terminal, and obtaining a file feature and an identification code of the terminal included in the data upload request;
the security control server judging whether the terminal is a trustable machine according to the identification code of the terminal, wherein the trustable machine is a terminal in which data is considered to be security data
if the terminal is judged as the trustable machine, the security control server obtaining a real-time state of the terminal from a real-time state record table, and adding the uploaded file feature to a security database if the terminal is in a working state, and not adding the uploaded file feature to the security database if the terminal is in an idle state.
